(19) United States
(12) Patent Application Publication
(10) Pub. No.: US 2023/0256728 A1
(43) Pub. Date: Aug. 17, 2023

(54) PRINTING SYSTEM, SOFT DEPOSIT SYSTEM, SANITARY MASK PRINTING SYSTEM, SUSTAINABLE MASK PRINTING SYSTEM, PROCESSES, AND METHODS OF USE

(71) Applicant: David Leary, Broadway, NJ (US)

(72) Inventor: David Leary, Broadway, NJ (US)

(21) Appl. No.: 18/107,810

(22) Filed: Feb. 9, 2023

Related U.S. Application Data
(60) Provisional application No. 63/309,700, filed on Feb. 14, 2022.

(51) Int. Cl. B41F 17/00; A41D 13/11

(52) U.S. Cl. CPC B41F 17/003; A41D 13/11

(57) ABSTRACT

A printing system, a soft deposit system, a sanitary mask printing system, a sustainable mask printing system, processes, and methods of use are presented. The present disclosure provides the state of the art with a printing system for printing on delicate material. Whereas delicate material has been impossible to consistently, rapidly, and efficiently print upon, the present disclosure relates to a printing process and method of printing for printing custom pieces on delicate sustainable masks. More specifically, and without limitation, the present disclosure relates to a process and method of printing with respect to healthcare and virtual reality sanitary masks.

### CROSS-REFERENCE TO RELATED APPLICATIONS

The present application claims priority to the U.S. Provisional Patent Application No. 63/309,700 which was filed on Feb. 14, 2022, which is hereby incorporated by reference herein in its entirety, including any figures, tables, or drawings.

### FIELD OF THE DISCLOSURE

This disclosure relates to a printing system, a soft deposit system, a sanitary mask printing system, a sustainable mask printing system, processes, and methods of use. More specifically, and without limitation, the present disclosure relates to a printing system for printing on delicate material. More specifically, and without limitation, the present disclosure relates to a printing process and method of printing for printing custom pieces on delicate sustainable masks. More specifically, and without limitation, the present disclosure relates to a process and method of printing with respect to healthcare and virtual reality sanitary masks.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document. Copyright. David E. Leary. All rights reserved.

### BACKGROUND OF THE DISCLOSURE

In recent times, cleanliness has become more important than ever. With the spreading of viruses, such as covid-19, other germs and the like. Industries from hospitals to restaurants and the like strive for sanitary environments safe for visitors and interactions. In this way, businesses strive to protect clients in creative ways.

In striving for the health of individuals, and safe and sanitary environments, various masks have become required. Masks which cover the mouth and face have grown common to prevent the spread of airborne particles. Similarly, other masks, such as those used on equipment and/or in hospitals, virtual reality training, military virtual reality training, academic virtual reality training, virtual reality trade shows and events, augmented reality trade shows and events, doctors offices and the like have become common for covering equipment and the like. For example, sustainable masks are used in eye doctor offices to cover equipment which clients and/or patients use. In this way, an office can use a sustainable mask and/or cover to interface between a piece of equipment and a user. Once the engagement between the user and equipment is concluded, the cover can be easily removed and replaced by a sanitary cover.

sustainable covers exist in various places within the art. We see face masks being used which are sanitary, used regularly and worldwide. We also see virtual reality headset masks utilized for sanitary purposes. This occurs at stores, conferences, and other locations where a set may have more than a single user. Additionally, we see doctor office masks in various applications such as at an optometry office on various types of machines and equipment. Some examples of places for mask use include use with tonometers, phoropters, retinoscopes, vision screeners and vision screening machines, and the like.

One issue with sustainable masks is that they can not be printed on. sustainable masks are generally very thin. For this reason, custom masks are rare and/or can be expensive to create. Printing and, thus, customization is not an option when it comes to sustainable mask appearances at conferences, at doctors offices, at restaurants, and other locations. There are many missed opportunities for marketing and customization and the like.

Thus, there is a long-felt need in the art for a system, process, and methodology which provides for printing on these sensitive and/or thin masks to be used in a variety of applications such as virtual reality headsets, doctors offices, and more.

The disclosure herein provides these advantages and others as will become clear from the specification and claims provided.

### SUMMARY OF THE DISCLOSURE

A printing system, a soft deposit system, a sanitary mask printing system, a sustainable mask printing system, processes, and methods of use. Said another way, and without limitation, the present disclosure provides the state of the art with a printing system for printing on delicate material. Additionally, the present disclosure provides the state of the art with a printing process and method of printing for printing custom pieces on delicate sustainable masks. More specifically, and without limitation, the present disclosure provides the state of the art with a process and method of printing with respect to healthcare and virtual reality sanitary masks.

Thus, it is a primary object of the disclosure to provide a printing system, a soft deposit system, a sanitary mask printing system, a sustainable mask printing system, processes, and methods of use that provides for the ability to print on sanitary masks.

Another object of the disclosure is to provide a printing system, a soft deposit system, a sanitary mask printing system, a sustainable mask printing system, processes, and methods of use that provides a clean customized sanitary mask.

Yet another object of the disclosure is to provide a printing system, a soft deposit system, a sanitary mask printing system, a sustainable mask printing system, processes, and methods of use that provides a safe, customized sanitary mask.

Another object of the disclosure is to provide a printing system, a soft deposit system, a sanitary mask printing system, a sustainable mask printing system, processes, and methods of use that provides for the ability to custom print on delicate materials.

Yet another object of the disclosure is to provide a printing system, a soft deposit system, a sanitary mask printing system, a sustainable mask printing system, processes, and methods of use that provides the ability to custom print on very thin materials.

Another object of the disclosure is to provide a printing system, a soft deposit system, a sanitary mask printing system, a sustainable mask printing system, processes, and methods of use that provides for mass production of custom, sustainable sanitary masks.

Yet another object of the disclosure is to provide a printing system, a soft deposit system, a sanitary mask printing system, a sustainable mask printing system, processes, and methods of use that protects a user.

Another object of the disclosure is to provide a printing system, a soft deposit system, a sanitary mask printing system, a sustainable mask printing system, processes, and methods of use that can promote brands.

Yet another object of the disclosure is to provide a printing system, a soft deposit system, a sanitary mask printing system, a sustainable mask printing system, processes, and methods of use that can print on healthcare grade sanitary masks.

Another object of the disclosure is to provide a printing system, a soft deposit system, a sanitary mask printing system, a sustainable mask printing system, processes, and methods of use that can provide mass produced, customized, virtual reality sanitary masks.

Yet another object of the disclosure is to provide a printing system, a soft deposit system, a sanitary mask printing system, a sustainable mask printing system, processes, and methods of use that can provide mass produced, customized, virtual reality washable masks.

Another object of the disclosure is to provide a printing system, a soft deposit system, a sanitary mask printing system, a sustainable mask printing system, processes, and methods of use that provides sanitary masks with printed company logos.

Yet another object of the disclosure is to provide a printing system, a soft deposit system, a sanitary mask printing system, a sustainable mask printing system, processes, and methods of use that eliminates the need for cleaning virtual reality masks between uses.

Another object of the disclosure is to provide a printing system, a soft deposit system, a sanitary mask printing system, a sustainable mask printing system, processes, and methods of use that provide a high quality product made of soft material that is breathable.

Yet another object of the disclosure is to provide a printing system, a soft deposit system, a sanitary mask printing system, a sustainable mask printing system, processes, and methods of use that provides for printing on a mask with a relatively affordable cost.

Another object of the disclosure is to provide a printing system, a soft deposit system, a sanitary mask printing system, a sustainable mask printing system, processes, and methods of use that provide for consistent printing.

Yet another object of the disclosure is to provide a printing system, a soft deposit system, a sanitary mask printing system, a sustainable mask printing system, processes, and methods of use that protects personal hygiene.

Another object of the disclosure is to provide a printing system, a soft deposit system, a sanitary mask printing system, a sustainable mask printing system, processes, and methods of use that are sanitary and safe.

Yet another object of the disclosure is to provide a printing system, a soft deposit system, a sanitary mask printing system, a sustainable mask printing system, processes, and methods of use that provide the ability for users to share virtual reality headsets.

Another object of the disclosure is to provide a printing system, a soft deposit system, a sanitary mask printing system, a sustainable mask printing system, processes, and methods of use that provide customized masks for gaming, healthcare, and education, among other fields and industries.

Yet another object of the disclosure is to provide a printing system, a soft deposit system, a sanitary mask printing system, a sustainable mask printing system, processes, and methods of use that provide sanitary conditions, even when headsets are shared between multiple users.

Another object of the disclosure is to provide a printing system, a soft deposit system, a sanitary mask printing system, a sustainable mask printing system, processes, and methods of use that eliminate the need to clean headsets between uses while providing customization on a mask.

Yet another object of the disclosure is to provide a printing system, a soft deposit system, a sanitary mask printing system, a sustainable mask printing system, processes, and methods of use that provides for printed high-quality sanitary virtual reality masks.

Another object of the disclosure is to provide a printing system, a soft deposit system, a sanitary mask printing system, a sustainable mask printing system, processes, and methods of use that provide a user to confidently share a headset while creating a personalized experience.

Yet another object of the disclosure is to provide a printing system, a soft deposit system, a sanitary mask printing system, a sustainable mask printing system, processes, and methods of use that utilizes sublimation.

Another object of the disclosure is to provide a printing system, a soft deposit system, a sanitary mask printing system, a sustainable mask printing system, processes, and methods of use that are easy to use.

Yet another object of the disclosure is to provide a printing system, a soft deposit system, a sanitary mask printing system, a sustainable mask printing system, processes, and methods of use that are safe to use.

Another object of the disclosure is to provide a printing system, a soft deposit system, a sanitary mask printing system, a sustainable mask printing system, processes, and methods of use that are accurate.

Yet another object of the disclosure is to provide a printing system, a soft deposit system, a sanitary mask printing system, a sustainable mask printing system, processes, and methods of use that are quick and efficient.

Another object of the disclosure is to provide a printing system, a soft deposit system, a sanitary mask printing system, a sustainable mask printing system, processes, and methods of use that are robust.

Yet another object of the disclosure is to provide a printing system, a soft deposit system, a sanitary mask printing system, a sustainable mask printing system, processes, and methods of use that saves time for a user.

Another object of the disclosure is to provide a printing system, a soft deposit system, a sanitary mask printing system, a sustainable mask printing system, processes, and methods of use that are high quality.

Another object of the disclosure is to provide a printing system, a soft deposit system, a sanitary mask printing system, a sustainable mask printing system, processes, and methods of use that are configured to prevent jamming and/or inaccuracies causing delays.

These and other objects, features, or advantages of the present disclosure will become apparent from the specification and claims.

### BRIEF DESCRIPTION OF THE DRAWINGS

FIG. 1 is an example of one embodiment of a sanitary mask and printing system; the view showing a sanitary mask; the view showing a sanitary mask of an irregular shape; the view showing visual apertures; the view showing attachment features; the view showing printing possibilities.

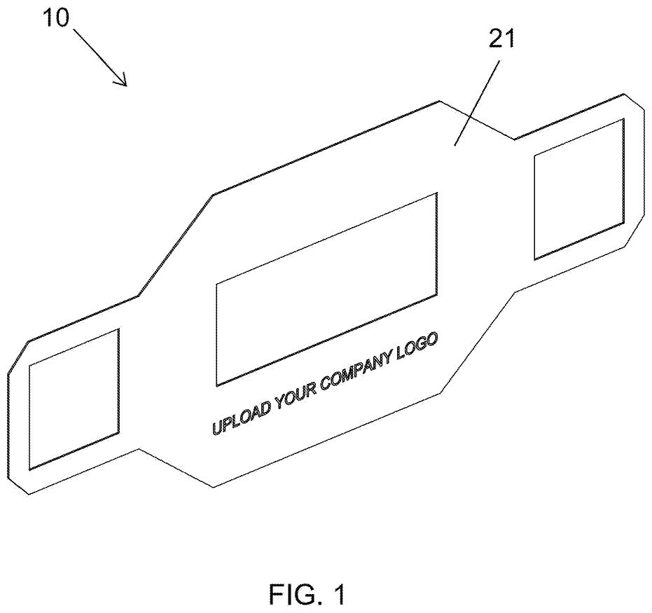

FIG. 2 is an example of one embodiment of a sanitary mask and printing system; the view showing a sanitary mask; the view showing a sanitary mask of an irregular shape; the view showing visual apertures; the view showing attachment features; the view showing printing possibilities.

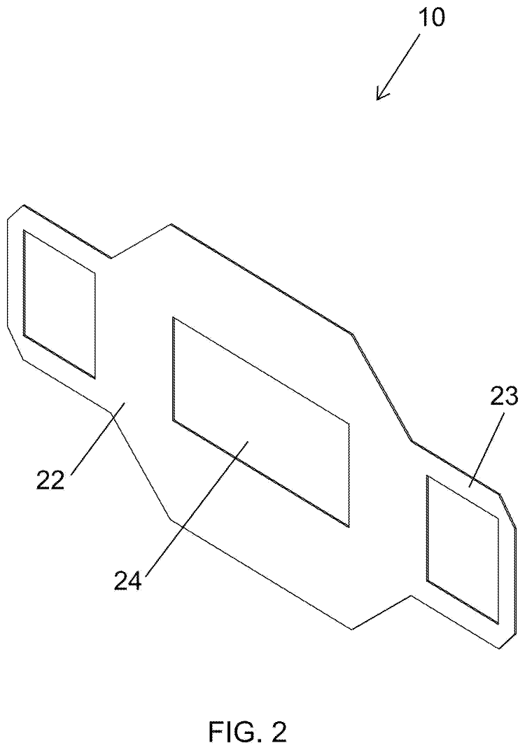

FIG. 3 is an example of one embodiment of a sanitary mask and printing system; the view showing a sanitary mask; the view showing a sanitary mask of an irregular shape; the view showing visual apertures; the view showing attachment features; the view showing printing possibilities.

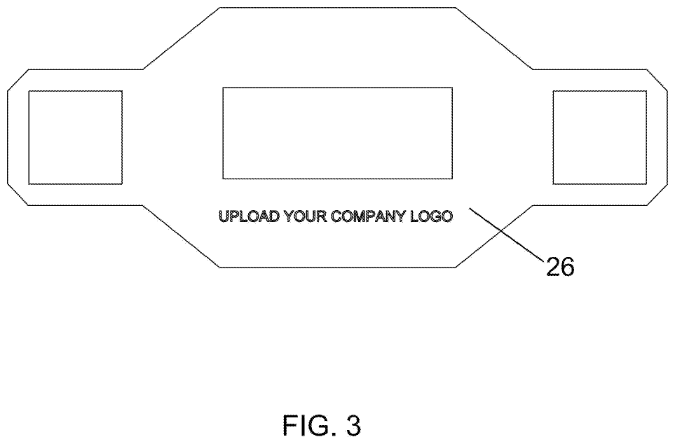

FIG. 4 is an example of one embodiment of a sanitary mask and printing system; the view showing a sanitary mask; the view showing a sanitary mask of an irregular shape; the view showing visual apertures; the view showing attachment features; the view showing printing possibilities.

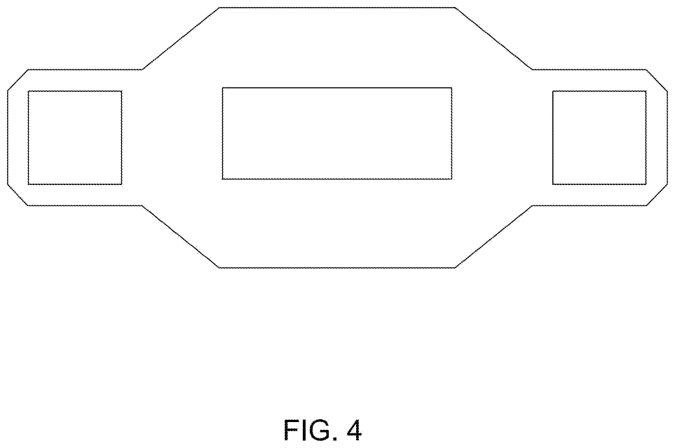

FIG. 5 is an example of one embodiment of a sanitary mask and printing system; the view showing a sanitary mask; the view showing a sanitary mask of an irregular shape; the view showing visual apertures; the view showing attachment features; the view showing printing possibilities; the view showing a virtual reality headset system.

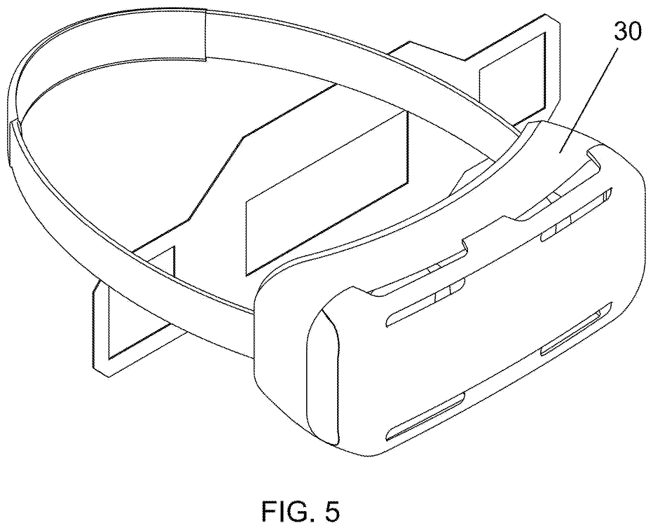

FIG. 6 is a diagram of an example of one embodiment of the process of printing on a delicate material as provided herein.

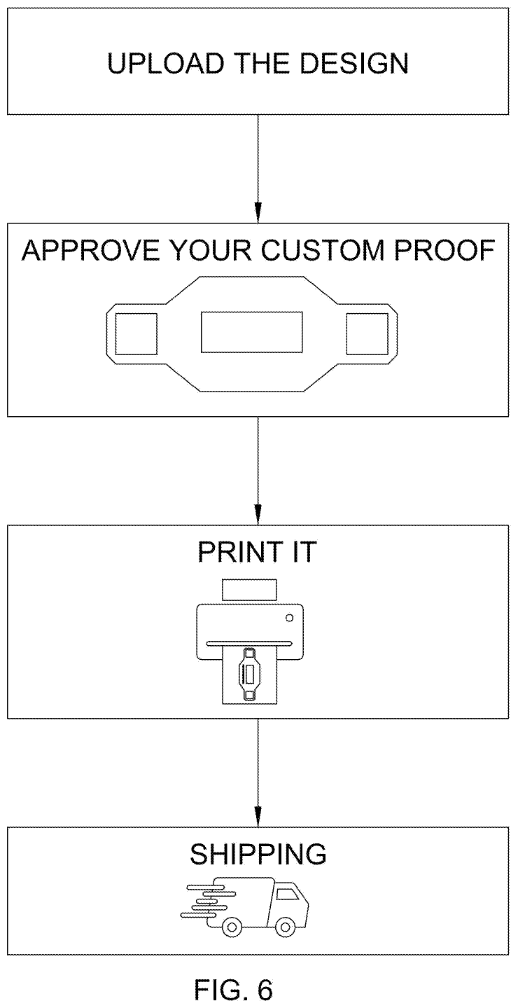

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer removable drive, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code, or virtual code, or framework code suitable for the disclosure herein, or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“Saas”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

System:

With reference to the figures, a printing system, a soft deposit system, a sanitary mask printing system, a sustainable mask printing system, processes, and methods of use 10 are presented. Printing system, a soft deposit system, a sanitary mask printing system, a sustainable mask printing system, processes, and methods of use (also, herein, referred to as “printing system”, “soft deposit system”, “sanitary mask printing system”, “disposal mask printing system”, or simply “system”) is formed of any suitable size, shape and design.

In the arrangement shown, as one example, sanitary mask printing system 10 may include a plurality of users, a plurality of medical professionals, a surface, a plurality of masks 20, one or more pieces of equipment 30, and a printer, among other components, features, and functionality.

In the arrangement shown, as one example, printing system 10 may also comprise a graphical user interface, remote servers, databases, application servers, application databases, product databases, mobile applications, and/or computers; all of which in continuity or as separate acts fulfill the functions disclosed herein. Soft deposit system 10, as standalone or integrated functionality, may also include a computing system, a communication and/or control system, an application server, an ordering system, and a mobile computing application, among other components, features, and functions.

User (or Plurality Thereof):

In the arrangement shown, as one example, system 10 includes a user. User may be any user interacting with or utilizing the system 10. This may include viewing, wearing, applying, assisting in application of the actual mask. Similarly, this may also include viewing, controlling, accessing the printing system and associated components, such as the ordering system and/or the control systems.

Mask:

In the arrangement shown, as one example, system 10 includes a mask 20. Mask 20 is formed of any suitable size, shape, and design. Mask 20 is configured to provide a protective barrier between the user and the outside world and/or between the environment and the user. Similarly, mask 20 may be configured to provide a protective barrier between the user and a piece of equipment 30 (to be further described herein).

In the arrangement shown, as one example, mask 20 may be formed of a facial mask for covering the mouth and/or nose. In this way, the mask 20 prevents and is configured to prevent viruses, bacteria, and the like from escaping and entering. Said another way, mask 20, in this example, is configure to protect against harmful contaminants from entering the airways. In one arrangement, viruses and bacteria, and the like are mentioned. However, other contaminants may also be stopped by the mask 20.

In another arrangement, as is shown as another example, mask 20 may be formed of a barrier to be placed between a user and another surface. In one example, mask 20 is formed of a virtual reality mask. In this way, the virtual reality mask is a barrier (often a very slim barrier) which provides protection against transfer of harmful biological and/or toxic substances. In this way, the barrier acts for protecting against viruses and the like, but may also serve as a barrier against allergens and like. Said another way, a user may be allergic to the substance of the surface and the barrier protects against a reaction. In this example, the mask serves these and other purposes.

While a virtual reality headset is hereby contemplated for use in this example. Other examples of surfaces are also hereby contemplated for use with a mask 20 to serve as a barrier between the user and a surface. Other examples may include any equipment or surfaces which may have multiple users such as surfaces and equipment at conferences and/or doctors offices where a coordinator and/or a medical professional may need to quickly change masks for sanitary purposes and the like.

Furthermore, while a mask for the face is hereby contemplated for use, the mask may be covering different parts of the face, the ears, the head, or other parts of the body, such as hands and the like. Similarly, a mask may also refer to other personal protective equipment, such as but not limited to, bodysuits, front covers like bibs, toilet seat covers, and other barrier type equipment, and the like. Similarly, equipment and/or in hospitals, virtual reality training, military virtual reality training, academic virtual reality training, virtual reality trade shows and events, augmented reality trade shows and events, doctors offices are hereby contemplated as common use cases for equipment and masks for equipment.

In the arrangement shown, as one example, the mask 20 includes a front 21, a back 22, loops 23, apertures 24, padding, print surface 26, attachment features, guide features, print guide laser indicators, among other components.

Surface:

In the arrangement shown, as one example, mask 20 is described as a barrier between a user and a surface and/or equipment. In this way, and in the arrangement shown, as one example, system 10 may also include equipment 30 (also referred to as “surface”, or “environment”). Equipment 30 is formed of any equipment and/or surface which a user desires to have a barrier between. Similarly, this may simply be a surface and/or the environment and/or virtual reality headsets, and the like.

Printer:

In the arrangement shown, as one example, system 10 includes a printer. Printer is formed of any suitable size, shape, and design and is configured to provide a safe and effective printing solution to jamming, tearing, and for printing on soft, very thin surfaces such as the surfaces of sanitary masks, and the like.

In the arrangement shown, as one example, printer is configured as a sublimation printer. In this way, printer is configured to utilize heat and other catalysts to transfer dye and other printing materials onto a surface. In the arrangement shown, as one example, printer is configured to transfer dye and/or other printing materials such as color and the like in a way that can form intricate and detailed patterns and/or intricate and detailed designs on the surface of fabric and the like. In this way, the printer is configured to print custom designs and the like onto masks 20. Furthermore, the printer is configured to accomplish this rapidly and approximately error free such that delicate materials, such as thin and/or delicate masks can be successfully printed upon.

Graphical User Interface:

In the arrangement shown, as one example, system 10 may include a graphical user interface. Graphical user interface is formed of any suitable size shape and design and is configured to allow a user to view interact with, manipulate, and visually access environmental and system data and information, information related thereto, and/or view various data for various printing processes and/or printing orders and/or add information to a printing system and/or mask size and/or laser guided lines located on a mask and/or add information about a surface being printed on and/or object data and/or change the settings of the sensors and/or change the settings of the system. In this way, a graphical user interface may also include a plurality of displays and/or touch screens the like for interaction with the user interface.

Computing Platform:

In the arrangement shown, as one example, system 10 may include a computing platform (or “computer”, or “computer platform”). Computing platform is formed of any suitable size, shape, and design and is configured to provide computing support, power, and computing processing for both onboard computing functionality as well as communication for off-board or server computing functionality.

Remote Computing System:

In one arrangement, as is shown, system 10 includes a remote computing system (or “remote computing device”). Remote computing devices are formed of any suitable size, shape, and design and configured to handle onboard computing operations, as are necessary for the operation of the printing system 10. Remote computing devices may be connected with electronic network and/or database and/or server or cloud via communication means and includes a processor, a memory, a microcontroller, a printed circuit board, a microprocessor, a receiver/transceiver, may include at least one antenna, a power supply, and a communications system, among other components.

Sensor System:

In the arrangement shown, as one example, system 10 includes a sensor system. Sensor system is formed of any suitable size, shape, and design and may include one or more sensors and/or one or more sensing technologies. In the arrangement shown, as one example, sensor system is configured to detect and communicate information related to system 10 as well as the surroundings and/or environment of system 10.

Application Server:

In the arrangement shown, as one example, system 10 comprises remote servers, databases, and/or computers that fulfill the functions disclosed and described herein. In the embodiment depicted, system 10 comprises an application server. Application server comprises one or more computer systems adapted to transmit and receive data regarding selected datasets related to various users and/or datasets related to multiple users. Application server is adapted to query databases with unique identification codes to retrieve information.

In addition to the above identified features, options, controls, and components, system 10 may also include other features and functionalities, among other options, controls, and components.

In Operation (Process and Methods of Use):

In one example, a sublimation printing process and/or catalyst drive printing process and methods of use are hereby contemplated. These processes and methods of use describe the ability to print custom designs rapidly on fragile surfaces such as thin surfaces, sanitary masks, and the like.

In the arrangement shown, as one example, printing system 10 is configured to provide custom sanitary masks through a dye sublimation process. In one example, the masks are stitched out of cotton and polyester (similar to spandex).

In one example, the design and/or image and/or information is printed and/or applied to a sheet. The image is then heated and/or warmed onto the mask through a catalytic process. During this process, in this example, the ink and/or dye is turned into a gas. The gas then adheres to the fibers of the material, causing the image and/or design and/or information to be “printed” onto the fibers of the material.

It will be appreciated by those skilled in the art that other various modifications could be made to the system, process, and method of use without parting from the spirit and scope of this disclosure. All such modifications and changes fall within the scope of the claims and are intended to be covered thereby.

What is claimed:

1. A printing system, comprising:
a surface;
an environment;
a mask;
the mask having a front;
the mask having a back;
the mask having a print surface;
the mask having a plurality of guide features;
a printer;
the mask having a print guide laser indicator;
wherein the printer is configured to print on a soft material, the mask being made of a soft material;
wherein the printer is configured to print rapidly and repetitively on the soft material of the mask;
wherein the printer is guided by the print guide laser indicator, such that the printer detects from lasers where the mask is located on the belt and the plurality of guide features of the mask are located on the mask, such that the printer can line up with the mask and print on the mask.

2. The system of claim 1, further comprising:
wherein the mask is a sanitary mask.

3. The system of claim 1, further comprising:
an equipment;
wherein the equipment is a virtual reality headset.

4. The system of claim 1, further comprising:
wherein the mask is a sustainable mask.

5. The system of claim 1, further comprising:
wherein the printer creates a customized mask from printing a customized design on the front surface of the mask, the mask being made of a sanitary mask.

6. The system of claim 1, further comprising:
wherein the mask is a healthcare grade sanitary mask.

7. The system of claim 1, further comprising:
wherein the printer is configured to use sublimation for applying a customized design to the mask.

8. The system of claim 1, further comprising:
the mask having a plurality of attachment features;
wherein the plurality of attachment features are small grip features which enable the mask to remain in place on a conveyor belt during a printing process, wherein the printing process includes moving the mask into the environment for printing and moving the mask out of the printing environment after printing.

9. The system of claim 1, further comprising:
the mask having a plurality of loops.

10. The system of claim 1, further comprising:
the mask having a plurality of apertures.

11. The system of claim 1, further comprising:
the mask having a padding.

12. The system of claim 1, further comprising:
a graphical user interface;
a user;
wherein a user can utilize the graphical user interface to upload a customized design for the printer to print on the mask.

13. The system of claim 1, further comprising:
an order system;
the order system having a graphical user interface;
a user of the order system;
wherein a user can utilize the graphical user interface to upload a customized design for the printer to print on the mask and order a quantity of masks.

14. The system of claim 1, further comprising:
the printer having a sensor system;
the sensor system having a plurality of sensors;
the sensor system having a plurality of lasers;
the sensor system having a plurality of cameras.

15. The system of claim 1, further comprising:
a computing system;
a control system;
an order system;
a sensor system;
the sensor system having a plurality of sensors;
an application server;
a user;
wherein a user can utilize the graphical user interface to upload a customized design for the printer to print on the mask.

16. A printing system for printing on a delicate material in rapid succession, comprising:
a surface;
wherein the surface is a printing surface, the printing surface a relatively flat surface which the mask is at rest during printing;
a printing environment;
the printing environment is created by having a barrier which separates the printing environment within from an exterior environment, such that air movement and debris are kept free from the printing environment;
a mask;
the mask having a front;
the mask having a back;
the mask having a plurality of loops;
the mask having a plurality of apertures;
the mask having a padding;
the mask having a print surface;
the mask having a plurality of attachment features;
the mask having a plurality of guide features;
the mask having a print guide laser indicator;
an equipment;
a printer;
a graphical user interface;
a computing system;
a control system;
an order system;
an application server;
wherein the printer is configured to print on a soft material, the mask being made of a soft material;
wherein the printer is configured to print rapidly and repetitively on the soft material of the mask;
wherein the printer is guided by the print guide laser indicator, such that the printer detects from lasers where the mask is located on the belt and the plurality of guide features of the mask are located on the mask, such that the printer can line up with the mask and print on the mask.

17. The system of claim 16, further comprising:
wherein the equipment is a virtual reality headset, such that the mask is configured to be used with the virtual reality headset and disposed of after use.

18. The system of claim 16, further comprising:
a user;
wherein the user is a medical professional using the mask which is a sustainable sanitary mask.

19. The system of claim 16, further comprising:
the printer having a sensor system;
the sensor system having a plurality of sensors;
the sensor system having a plurality of lasers;
the sensor system having a plurality of cameras.

20. A method of printing on a material, the steps comprising:
providing a conveyor belt; the conveyor belt having a printing surface upon which a plurality of masks are placed on a plurality of printing surfaces; the plurality of masks being made of a delicate material;
placing a plurality of masks on a plurality of printing surface;
moving the conveyor belt so that the plurality of masks enter a printing environment having a barrier and a printer; the printer having a plurality of sensors;
detecting position of a mask by the plurality of sensors of the printer;
detecting a print guide on the front of the mask by the plurality of sensors of the printer;
adjusting print location based on the position of the mask;
printing a customized design on the mask.
